(19) United States
(12) Patent Application Publication
(10) Pub. No.: US 2018/0368596 A1
(43) Pub. Date: Dec. 27, 2018

(54) DRINK CONTAINER WITH CONVERTIBLE SPOUTS

(71) Applicant: NUK USA LLC, Tarrytown, NY (US)

(72) Inventors: Ralph W. Dowdell, III, Trenton, NJ (US); Evan Williams, Boston, MA (US)

(73) Assignee: NUK USA LLC, Tarrytown, NY (US)

(21) Appl. No.: 15/631,853

(22) Filed: Jun. 23, 2017

(51) Int. Cl. A47G 19/22; A47J 41/00; F25D 31/00

(52) U.S. Cl. CPC A47G 19/2272; B65D 90/00; F25D 31/007; A47J 41/0005

(57) ABSTRACT

A drink container with convertible spouts is provided. The drink container includes a lid that can be removably coupled to a container body having a volume to hold fluids. The lid can include a rigid spout. A flexible spout can be removably coupled to the lid. When the flexible spout is coupled to the lid, the flexible spout can be positioned to extend through the rigid spout and can be adjustable from an extended configuration, wherein at least a portion of the flexible spout extends above a top end of the rigid spout, to a retracted configuration, wherein all or substantially all of the flexible spout is at or below the top end of the rigid spout. The drink container can also include a spout cap rotatable with respect to the lid, which seals both the rigid spout and the flexible spout when the cap is in a closed configuration.

### FIELD OF THE DISCLOSURE

The present disclosure is generally directed to liquid containers and more particularly to a drink container convertible between a hard spout and a flexible spout.

### BACKGROUND

Conventional drink containers for children typically fall into one of two categories: hard spout cups and soft spout cups. Soft spout cups are typically more suitable for toddlers and younger children. As a child gets older, a hard spout cup is typically more suitable in order for the child to learn proper drinking techniques. One problem is that the consumer typically has to choose either between soft spout cups or hard spout cups. When the consumer purchases a soft spout cup, it may be useful for a period of time. However, as the child ages, the soft spout cup will no longer be useful and must be discarded because conventional soft spout cups cannot be converted to hard spout cups.

In addition, many soft spout cups can be very complex, including a number of parts and a complicated assembly that can make it difficult to properly clean the soft spout portion of the cup and can cause these cups to leak when reassembled by the user.

Some conventional soft spout and hard spout cups can also include a removable or rotatable lid to provide a seal over the soft spout or the hard spout and to prevent the cup from leaking thought the respective soft spout or hard spout. However, for those soft spout cups, if the user were to remove the soft spout and not replace it (e.g., in an effort to convert it to a hard spout cup), the lid no longer provided a seal to the hard spout in order to prevent the cup from leaking.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1A is a perspective view of a drink container in an open configuration with the adjustable flexible spout extending out from the rigid spout, in accordance with one example embodiment of the disclosure.

FIG. 1B is a perspective view of the drink container of 1A in a closed, sealed configuration, in accordance with one example embodiment of the disclosure.

FIG. 2 is a partial exploded view of the drink container, in accordance with one example embodiment of the disclosure.

FIG. 3 is a partial side cross-sectional view of the adjustable flexible spout, in accordance with one example embodiment of the disclosure.

FIGS. 4A and 4B are partial side cross-sectional views of the lid, cap, and adjustable flexible spout in the open configuration and the closed sealed configuration, in accordance with one example embodiment of the disclosure.

FIG. 5 is a partial side cross-sectional view of the lid and cap with the adjustable flexible spout removed in the closed configuration, in accordance with one example embodiment of the disclosure.

### DETAILED DESCRIPTION OF THE EXAMPLE EMBODIMENTS

Example embodiments will now be described more fully hereinafter with reference to the accompanying drawings, in which example embodiments are shown. The concepts disclosed herein may, however, be embodied in many different forms and should not be construed as limited to the example embodiments set forth herein; rather, these embodiments are provided so that this disclosure will be thorough and complete, and will fully convey the scope of the concepts to those skilled in the art. Like numbers refer to like, but not necessarily the same or identical, elements throughout.

Certain dimensions and features of the example drink container are described herein using the term “approximately.” As used herein, the term “approximately” indicates that each of the described dimensions is not a strict boundary or parameter and does not exclude functionally similar variations therefrom. Unless context or the description indicates otherwise, the use of the term “approximately” in connection with a numerical parameter indicates that the numerical parameter includes variations that, using mathematical and industrial principles accepted in the art (e.g., rounding, measurement or other systematic errors, manufacturing tolerances, etc.), would not vary the least significant digit.

In addition, certain relationships between dimensions of the drink container and between features of the drink container are described herein using the term “substantially.” As used herein, the terms “substantially” and “substantially equal” indicates that the equal relationship is not a strict relationship and does not exclude functionally similar variations therefrom. Unless context or the description indicates otherwise, the use of the term “substantially” or “substantially equal” in connection with two or more described dimensions indicates that the equal relationship between the dimensions includes variations that, using mathematical and industrial principles accepted in the art (e.g., rounding, measurement or other systematic errors, manufacturing tolerances, etc.), would not vary the least significant digit of the dimensions. As used herein, the term “substantially constant” indicates that the constant relationship is not a strict relationship and does not exclude functionally similar variations therefrom. As used herein, the term “substantially parallel” indicates that the parallel relationship is not a strict relationship and does not exclude functionally similar variations therefrom. As used herein, the term “substantially orthogonal” indicates that the perpendicular relationship is not a strict relationship and does not exclude functionally similar variations therefrom.

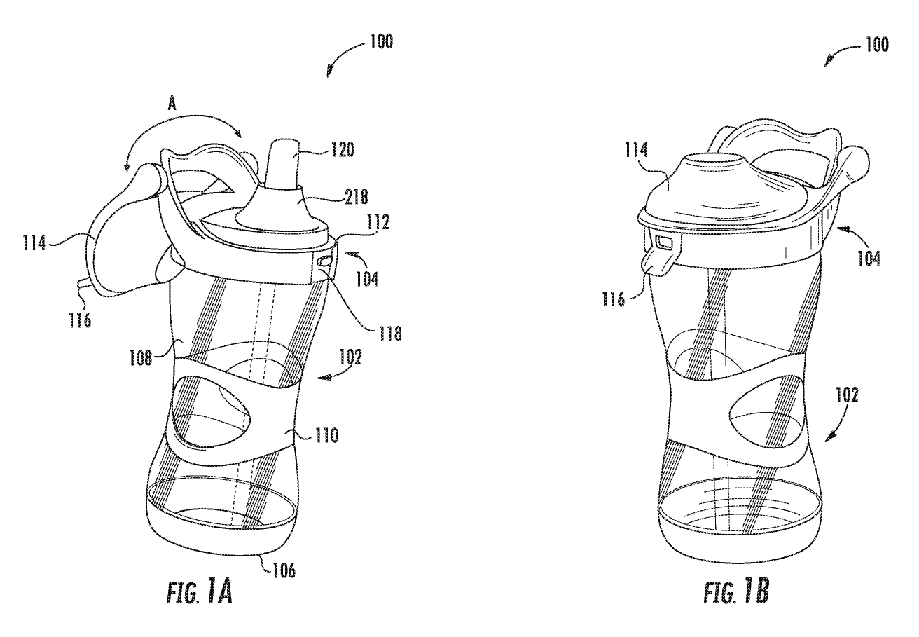

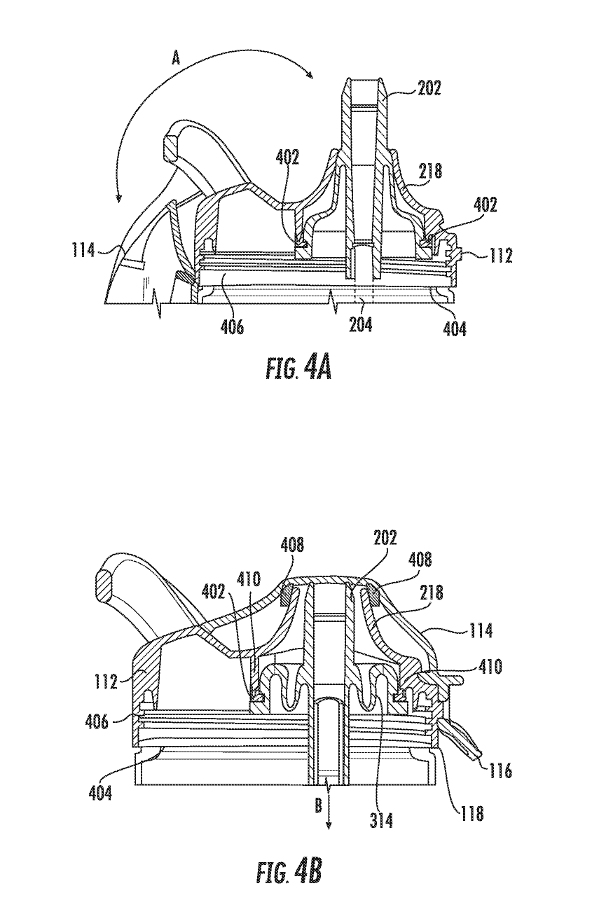

FIGS. 1A-1B are perspective views of a drink container 100 in an open configuration with the adjustable flexible spout extending out from the rigid spout and a closed sealed configuration, in accordance with one example embodiment of the disclosure. The use of the term sealed denotes that the drink container 100 does not leak liquid contained within the container between the lid and the spouts. Referring now to FIGS. 1A-B, the drink container 100 includes a container body 102 and a removable lid 104 removably coupled to the container body 102. In one example, the container body 102 can include a threaded exterior top end (see FIG. 4A) and the removable lid 104 can include a threaded interior bottom end (see FIG. 4A) that corresponds with and can be rotatably coupled to the threaded exterior top end of the container body 102. In other example embodiments, the container body 102 and/or the removable lid 104 can include other features known in the art to removably couple the removable lid 104 to the container body 102.

The container body 102 can include a bottom surface 106 and one or more side walls 108 extending up from the bottom end. While the example embodiment of FIG. 1 shows the drink container 100 having a wall 108 with a circular cross-section, other wall configurations with multiple walls 108 and other cross-sectional shapes, such as oval, square, rectangular, geometric, non-geometric, or abstract, are within the scope of this disclosure. The bottom surface 106 and one or more walls 108 define an enclosure configured to hold liquid or solid materials, such as drinking fluids. In certain example embodiments, the bottom surface 106 and the one or more side walls 108 are integrally formed together. Further, the bottom surface 106 and the one or more side walls 108 can be constructed of plastic, metal, metal alloy, or another material. In certain example embodiments, the container body 102 can also include a grip enhancer provided along the one or more side walls 108. In one example, the grip enhancer 102 can be a flexible band positioned around the one or more side walls. Alternatively, the grip enhancer can be one or more of a raised surface, a studded surface, or a friction increasing material applied to the outer surface of the one or more side walls 108.

The removable lid 104 can include a lid base 112 that can be threadably or non-threadably coupled to the container body 102. One example of non-threadably coupling is a removable lid that is removably coupled to the container body by a hinge. Other non-threadable examples are also within the scope of this disclosure. The removable lid 104 can also include a rigid (i.e., is not flexible) spout 218 disposed along the top surface of the lid base 112. In certain example embodiments, the rigid spout 218 can extend generally upward from the top surface of the lid base 112. In other example embodiments, the rigid spout 218 can be positioned at a height below the top surface of the lid base 112. The lid base 112 and the rigid spout 218 can be integrally formed together. In certain example embodiments, the lid base 112 and the rigid spout 218 can be constructed of plastic, metal, or a metal alloy that is generally rigid and not flexible or resilient. For example, the lid base 112 and rigid spout 218 can be constructed of polypropylene or another rigid plastic.

A cap 112 can be coupled to the removable lid 104 and configured to rotate in the directions A with respect to the removable lid 104 between an open configuration and a closed, sealed configuration. The removable lid 104 can include a cap retainer tab 118 positioned along the lid base 112. The cap can include a cap retainer slot 116 configured to receive at least partially therein and be removably coupled to the cap retainer tab 118 when the cap 114 is placed in the closed, sealed configuration to maintain the cap 114 in the closed, sealed position against potential forces from the adjustable spout 120.

The drink container 100 can also include an adjustable spout 120. The adjustable spout 120 can be removably coupled to the lid base, as discussed in greater detail with regard to FIGS. 4A-4B. The adjustable spout 120 is configured to be vertically adjustable from an extended configuration, as shown in FIG. 1A, to a retracted configuration, as shown in FIG. 4B. The adjustable spout 120 can extend up above and through top end of the rigid spout 218 in the extended configuration and can be manually pushed down by a downward force generated on the top end of the adjustable spout by the cap 114 (as it is being manually adjusted from the open configuration to the closed, sealed configuration) or by a user into the mouth of the rigid spout 218, as shown in FIG. 4B. In certain example embodiments, the adjustable spout 120 can include a straw that is removably or fixedly coupled to the adjustable spout 120 and can extend down from the adjustable spout 120 in the enclosure of the container body 102.

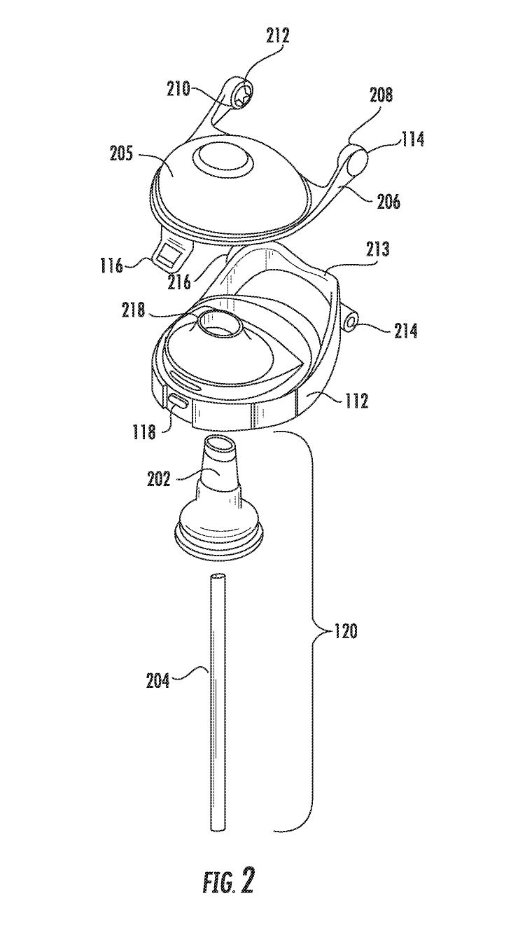

FIG. 2 is a partial exploded view of the drink container 100 of FIG. 1A-1B, in accordance with one example embodiment of the disclosure. Referring now to FIGS. 1A-2, the example adjustable spout 202 can include a flexible spout assembly 202 and a straw 204 removably or fixedly coupled to the flexible spout assembly 202. In one example embodiment, the straw 204 can be slidably inserted into a channel of the flexible spout assembly 202 to removably couple the straw 204 to the flexible spout assembly 202. The straw 204 can be flexible or rigid and can be made of plastic.

The rotatable cap 114 can include a main body 205 configured to cover all of the rigid spout 218 and the flexible spout 202 (when removably coupled to the lid base 112). The rotatable cap 114 can also include a first cap arm 206 that extends out from the main body 205 to a distal free end. The first cap arm 206 can include a first rotation hub 208 positioned at or adjacent to the first free end. The rotatable cap 114 can also include a second cap arm 210 that extends out from the main body 205 to a distal second free end. The second cap arm 206 can also include a second rotation hub 212 positioned at or adjacent to the second free end.

The lid base 112 can further include a handle 213 coupled to or integrally formed with the lid base 112. In one example embodiment, the handle 213 extends out from and is positioned generally higher than the lid base 112. The handle 213 can include one or more rotation axles. In one example embodiment, the handle 213 can include a first rotation axle 214 positioned along one side of the handle 213 and a second rotation axle 216 positioned along a second side of the handle 213. In another example embodiment, only one rotation axle is provided on the handle. In yet another example embodiment, the one or more rotation axles are positioned along a side edge of the lid base 112.

In one example embodiment, the first rotation hub 208 can be removably coupled to and rotate about the first rotation axle 214 and the second rotation hub 212 can be removably coupled to and rotate about the second rotation axle 216 to allow the cap 114 to rotate with respect to the lid base 112.

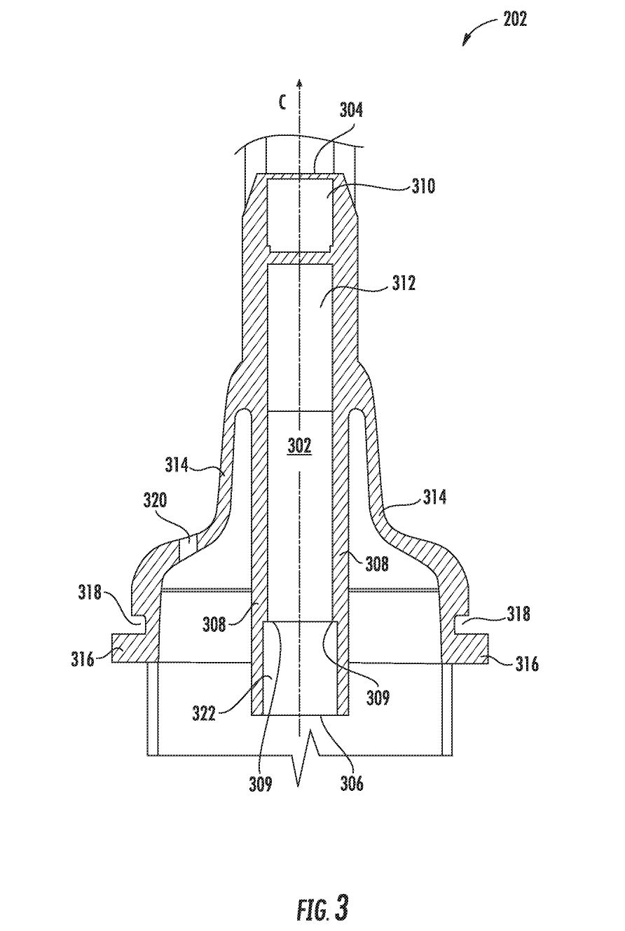

FIG. 3 is a partial side cross-sectional view of the adjustable flexible spout 202, in accordance with one example embodiment of the disclosure. Now referring to FIGS. 1A-3, the adjustable flexible spout 202 can include a top opening 304 and a bottom opening 306 that are fluidicly coupled by a fluid channel 302. In one example, the fluid channel 302 can extend from the top opening 304 to the bottom opening 306. In another example embodiment, such as that shown in FIG. 3, the fluid channel 302 can include or be fluidicly coupled to additional fluid flow elements between the top opening 304 and the bottom opening 306. The fluid channel 302 can be defined by one or more channel walls 308 disposed around the fluid channel 302. The channel wall 308 can have any cross-sectional shape. In one example, the channel wall 308 is an annular wall 308 made of plastic and the fluid channel is defined by the inner wall of the channel wall 308.

In one example embodiment, the channel wall 308 can have a diameter adjacent the bottom opening 306 that is greater than the diameter of the remainder of the channel wall 308. This junction of the greater diameter and the lesser diameter of the channel wall can define or create a straw stop 309. The straw 204 can have a diameter such that it is able to be slidably inserted into the channel and fit within the greater diameter channel wall 308 but not the lesser diameter channel wall 308 and the straw stop 309 prevents the straw 204 from being further slidably inserted into the channel 302 of the adjustable flexible spout 202.

The adjustable flexible spout 202 can further include a dispensing spout 310 disposed adjacent the top opening 304 and fluidicly coupled, either directly or indirectly to the fluid channel 302. The example adjustable flexible spout 202 can also include a bite valve 312 positioned between the dispensing spout 310 and the remainder of the fluid channel 302. The bite valve 312 can control the flow of fluid from fluid channel 302 to the dispensing spout 310. for example, the bite valve 312 can require that opposing inward pressure be applied generally to opposing outer sides of the channel wall 308 to squeeze the bite valve 312 and cause it to open and allow fluid to pass between the fluid channel 302 and the dispensing spout 310.

The adjustable flexible spout 202 can also include a generally bell shaped spring diaphragm wall 314 that extends out from the outer wall of the channel wall 308 to the spout base 316. The spring diaphragm wall 314 can be an annular wall having differing cross-sectional diameters along its height. The spring diaphragm wall 314 is flexible and configured to bend as the adjustable flexible spout 202 is adjusted downward from the extended configuration to the retracted configuration. The spring diaphragm wall 314 also provides a spring bias to the adjustable flexible spout 202 to bias the adjustable flexible spout 202 into the extended configuration. The bottom portion of the spring diaphragm wall 314 can have a generally annular shape and provide for a generally annular opening that has a diameter that is greater than the diameter of the bottom opening 306 of the fluid channel 302.

The spring diaphragm wall 314 can be thicker along the bottom portion of the spring diaphragm wall 314 than along the top portion of the spring diaphragm wall 314. When in the retracted configuration, the bending of the spring diaphragm wall 314 can create an over center spring effect that generates a vertical force in the direction C. This vertical force in the direction C causes the adjustable flexible spout 202 to transition from the retracted configuration to the extended configuration automatically when the downward force applied by the bottom side of the cap 114 is removed (e.g., when the cap 114 begins to be rotated from the closed, sealed configuration to the open configuration). In one example, the spring diaphragm wall 314 is made of plastic, such as silicone. However, other flexible and resilient materials can be used to construct the spring diaphragm wall 314.

The adjustable flexible spout 202 can also include a slot 318 disposed in the outer wall of the spring diaphragm wall 314. In one example, the slot 318 is an annular slot disposed around the entire circumference of the spring diaphragm wall 314. The slot 318 can be positioned adjacent the spout base 316. The slot 318 can be configured to receive a tab (see FIG. 4A) that is part of the lid base 112 and/or rigid spout 218 to removably couple the adjustable flexible spout 202 to the removable lid. The adjustable flexible spout 202 can also include a vacuum relief vent 320 positioned along the spring diaphragm wall 314. The vacuum relief vent 320 provides a fluidic passageway between the area inside the spring diaphragm wall 314 and the area outside the spring diaphragm wall 314 to eliminate or reduce the build-up of vacuum within the container body 102 when a child is drawing in fluid from the container body 102 through the adjustable flexible spout 202.

FIGS. 4A and 4B are partial side cross-sectional views of the lid base 112, cap 114, and adjustable flexible spout 202 of the drink container 100 of FIG. 1A in the open configuration and the closed, sealed configuration, in accordance with one example embodiment of the disclosure. Now referring to FIGS. 1A-4B, the lid base 112 includes a cavity that is generally defined by the outer wall of the lid base 112, the rigid spout 218 and the bottom opening of the lid base 112. The lid base 112 and/or the rigid spout 218 can include an annular tab 402 that extends from a top side of the lid base or a bottom end of the rigid spout 218 and can extend into the cavity of the lid base 112. For example, a rigid spout annular wall 410 can extend vertically down into the cavity of the lid base 112. The annular tab 402 can then extend radially inward from the rigid spout annular wall 410 in an orthogonal or substantially orthogonal manner. The annular tab 402 can be sized and shaped to be received in the annular slot 318 of the adjustable flexible spout 202.

In addition, as shown in FIGS. 4A and 4B, the drink container 100 can have corresponding male and female thread for threadably coupling the removable lid 104 to the container body 102. For example, the lid base 112 can include a threaded interior edge 404 positioned at or adjacent to a bottom edge of the lid base 112. In one example, the threaded interior edge 404 can include female threads, however, it could alternatively include male threads. The top end of the container body 102 can include a threaded exterior edge 406. For example, the threaded exterior edge 406 can include male threads that correspond with the female threads of the threaded interior edge 404 of the lid base 112. However, in alternative example embodiments, the threaded exterior edge 406 can include female threads. In another example embodiment, the removable lid 104 can be non-threadably coupled to the container body 102.

The bottom side of the cap 114 can further include a seal 408. In one example, the seal 408 can include one or more raised surfaces of material that extend tangentially down from the bottom side of the rotatable cap 114. For example, the seal 408 can be one or more sealing ribs or sealing rings that extend tangentially down from the bottom side of the cap 114. The seal 408 can be made of a resilient material. For example, the seal 408 can be made of plastic, such as p-polyethylene (PPE), that is spun welded to the bottom side of the cap 114. The seal 408 can be positioned along the bottom side of the cap 114 such that the seal 408 sealingly engages the top end of the rigid spout 218 when the cap is in the closed, sealed configuration, as shown in FIG. 4B. The bottom side of the rotatable cap 114 and or the seal 408 disposed along the bottom side of the cap 114 can also contact and provide a downward force in the direction B against the adjustable flexible spout 202 as the rotatable cap is rotated along the arc A from the open configuration to the closed, sealed configuration. In certain example embodiments, the bottom side of the cap 114 also sealingly engages the flexible spout 202. In other example embodiments, the bite valve 312 of the adjustable flexible spout 202 prevents fluid from passing from the enclosure of the container body 102 through the straw 204 and the channel 302 and out of the dispensing spout 310.

In use, as a user rotates the cap 114 with respect to the lid base 112 along the arc A from the open configuration towards the closed, sealed configuration, the bottom side of the cap 114 contacts the top end of the adjustable flexible spout 202. The force used to further rotate the cap 114 along the arc A causes the bottom side of the cap 114 to apply a downward force in the direction B on the adjustable flexible spout 202 and causes the straw 204 and the adjustable flexible spout 202 to move in the direction B. As the flexible spout 202 moves in the direction B, the top portion of the spring diaphragm wall 314 moves radially inward of the bottom portion of the spring diaphragm wall 314 and forces the bottom portion of the spring diaphragm wall 314 radially outward against the rigid spout annular wall 410. This radially outward force against the bottom portion of the spring diaphragm wall 314 causes an improved seal between the outer surface of the adjustable flexible spout 202 and the inner surface (e.g., the inner surface of the rigid spout annular wall and the annular tab 402) of the rigid spout 218, as shown in FIG. 4B. The cap 114 is further rotated along the arc A towards the closed, sealed configuration until at least a portion of the cap retainer tab 118 is positioned through the cap retainer slot 116 on the cap 114 to hold the cap 114 in the closed sealed configuration. The seal 408 along the bottom side of the cap 114 sealingly engages the rigid spout 218 and the top end of the adjustable flexible spout 202 contacts and applies an upward forces in the direction opposite B against the bottom side of the cap 114 due to the spring bias of the spring diaphragm wall 314.

When the cap is rotated along the arc A from the closed, sealed configuration towards the open configuration, the spring biasing of the adjustable flexible spout 202 in the direction opposite B caused by the spring diaphragm wall 314 automatically forces, without user interaction with the flexible spout 202, at least the top portion of the adjustable flexible spout 202 upward in the direction opposite B through the top end of the rigid spout 218 to extend out above the top end of the rigid spout 218.

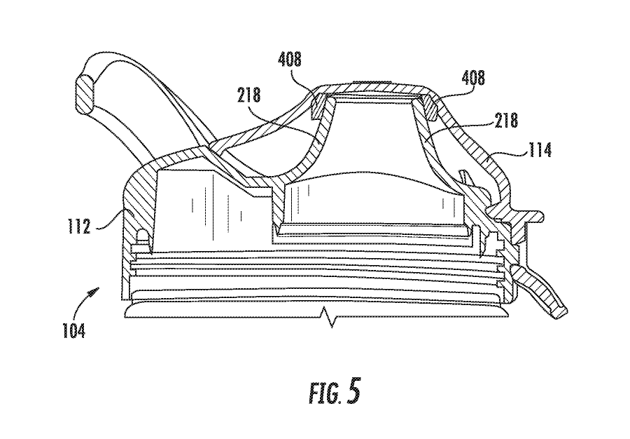

FIG. 5 is a partial side cross-sectional view of the removable lid 104 and cap 114 with the adjustable flexible spout 202 and straw 204 removed and the cap 114 in the closed, sealed configuration, in accordance with one example embodiment of the disclosure. Referring to FIGS. 1A-5, the seal 408 along the bottom side of the cap 114 sealingly engages the rigid spout 218 even when the flexible spout 202 is decoupled from the removable lid 104. The adjustable flexible spout 202 can be decoupled from the removable lid 104 by, for example, applying downward force in the direction B on the adjustable flexible spout 202 until the annular tab 402 is removed from the annular slot 318. The adjustable flexible spout 202 and straw 204 can then be removed from the drink container 100 and the drink container 100 is still functional with only the rigid spout 218 and the cap 114 still provides a seal against the rigid spout 218 to prevent leakage of fluids between the rigid spout 218 and the cap 114.

The adjustable flexible spout 202 and straw 204, now removed from the removable lid 104, the adjustable flexible spout 202 and straw can be more easily and properly cleaned. Further the user can recouple the adjustable flexible spout 202 and straw 204 to the removable lid 104 by inserting the adjustable flexible spout 202 up through the bottom of the lid base 112 and into the rigid spout 218 and providing a force against the adjustable flexible spout 202 in the direction opposite B until the annular tab 402 is seating into the annular slot 318.

Though the disclosed example includes a particular arrangement of a number of parts, components, features, and aspects, the disclosure is not limited to only that example or arrangement. Any one or more of the parts, components, features, and aspects of the disclosure can be employed alone or in other arrangements of any two or more of the same.

Although certain drink container features, functions, components, and parts have been described herein in accordance with the teachings of the present disclosure, the scope of coverage of this patent is not limited thereto. On the contrary, this patent covers all embodiments of the teachings of the disclosure that fairly fall within the scope of permissible equivalents.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A drink container comprising:
a container body defining an enclosure;
a lid removably coupled to the container body, the lid comprising:
a lid base; and
a rigid spout;
a flexible spout removably coupled to the lid and adjustable from an extended configuration to a retracted configuration;
a cap coupled to the lid and rotatable with regard to the lid from an open configuration to a closed configuration, wherein the cap sealingly engages the rigid spout in the closed configuration.

2. The drink container of claim 1, further comprising a straw removably coupled to the flexible spout.

3. The drink container of claim 1, wherein the cap comprises a top surface and an opposing bottom surface and wherein a sealing material is disposed along the bottom surface to sealingly engage the rigid spout in the closed configuration.

4. The drink container of claim 1, wherein the flexible spout comprises:
a top opening configured to dispense fluids;
a bottom opening configured to receive fluids from the enclosure; and
a channel wall defining a fluid channel between the top opening and the bottom opening.

5. The drink container of claim 4, wherein the flexible spout further comprises a bite valve disposed between the top opening and the bottom opening.

6. The drink container of claim 4, wherein the flexible spout further comprises a spring diaphragm wall coupled to the channel wall and extending downward from the channel wall, wherein the spring diaphragm wall spring biases the flexible spout in the extended configuration.

7. The drink container of claim 6, wherein the spring diaphragm wall further comprises a vacuum relief vent disposed through the spring diaphragm wall.

8. The drink container of claim 6,
wherein the lid base further comprises a top surface and a lid side wall extending down from the top surface, wherein the top surface and the lid side wall define a lid enclosure;
wherein the lid further comprises an annular tab disposed within the lid enclosure;
wherein the spring diaphragm wall further comprises an annular slot disposed in an outer surface of the spring diaphragm wall; and
wherein at least a portion of the annular tab is positioned within the annular slot to removably couple the flexible spout to the lid.

9. The drink container of claim 6, wherein the spring diaphragm wall further comprises a top wall portion comprising a first wall thickness and a bottom wall portion comprising a second wall thickness, wherein the first wall thickness is less than the second wall thickness.

10. The drink container of claim 6, wherein at least a portion of the spring diaphragm wall defines a wave profile comprising at least one peak and one trough when the flexible spout is in the retracted configuration.

11. The drink container of claim 1, wherein the lid comprises at least one rotation axle and the cap comprises at least one rotation hub, wherein the at least one rotation hub is movably coupled to the at least one rotation axle.

12. The drink container of claim 1, wherein the flexible spout is disposed within the rigid spout.

13. A drink container comprising:
a container body defining an enclosure;
a lid removably coupled to the container body, the lid comprising:
a lid base; and
a rigid spout;
a cap coupled to the lid and rotatable with regard to the lid from an open configuration to a closed configuration, wherein the cap sealingly engages the rigid spout in the closed configuration; and
a flexible spout positioned through the rigid spout and adjustable from an extended configuration to a retracted configuration, the flexible spout comprising:
a channel wall defining a fluid channel;
a spring diaphragm wall coupled to the channel wall and extending downward from the channel wall, wherein the spring diaphragm wall spring biases the flexible spout in the extended configuration and wherein the flexible spout is removably coupled to the lid.

14. The drink container of claim 13, wherein the flexible spout further comprises:
a bite valve disposed adjacent a first end of the flexible spout; and
a straw slidably coupled to a second end of the flexible spout opposite the first end.

15. The drink container of claim 13,
wherein the lid base further comprises a top surface and a lid side wall extending down from the top surface, wherein the top surface and the lid side wall define a lid enclosure;
wherein the lid further comprises an annular tab disposed within the lid enclosure;
wherein the spring diaphragm wall further comprises an annular slot disposed in an outer surface of the spring diaphragm wall; and
wherein at least a portion of the annular tab is positioned within the annular slot to removably couple the flexible spout to the lid.

16. The drink container of claim 13, wherein the cap comprises a top surface and an opposing bottom surface and wherein an annular sealing material is disposed along the bottom surface, and wherein the annular sealing material contacts the rigid spout in the closed configuration.

17. The drink container of claim 13, wherein the rigid spout is integrally formed with the lid base, wherein the rigid spout is formed of rigid plastic and the flexible spout is formed at least in part from silicone.

18. The drink container of claim 13, wherein the lid comprises at least one rotation axle and the cap comprises at least one rotation hub and wherein the at least one rotation hub is movably coupled to the at least one rotation axle.

19. A drink container comprising:
a container body defining an enclosure;
a lid removably coupled to the container body, the lid comprising:
a lid base comprising
a top surface: and
a lid side wall extending down from the top surface, wherein the top surface and the lid side wall define a lid enclosure;
an annular tab disposed within the lid enclosure
a rigid spout;
a cap movably coupled to the lid and adjustable from an open configuration to a closed configuration, wherein the cap sealingly engages the rigid spout in the closed configuration; and
a flexible spout positioned through rigid spout and adjustable from an extended configuration to a retracted configuration, the flexible spout comprising:
a channel wall defining a fluid channel;
a spring diaphragm wall coupled to the channel wall and extending downward from the channel wall; and
an annular slot disposed in an outer surface of the flexible spout
wherein at least a portion of the annular tab is positioned within the annular slot to removably couple the flexible spout to the lid.

20. The drink container of claim 19, wherein the flexible spout is spring biased in the extended configuration and wherein at least a portion of the flexible spout extends about a top end of the rigid spout in the extended configuration.
